(19) United States
(12) Patent Application Publication
(10) Pub. No.: US 2025/0192688 A1
(43) Pub. Date: Jun. 12, 2025

(54) CONTROL CIRCUIT AND METHOD FOR ISOLATED SWITCHING-MODE CONVERTER

(71) Applicant: SHANGHAI BRIGHT POWER SEMICONDUCTOR CO., LTD., Shanghai (CN)

(72) Inventors: Pengbo YANG, Shanghai (CN); Liqiang HU, Shanghai (CN); Zhen ZHU, Shanghai (CN); Yanmei GUO, Shanghai (CN); Shuai WU, Shanghai (CN); Qinyuan TIAN, Shanghai (CN); Fengfan ZHANG, Shanghai (CN)

(21) Appl. No.: 18/975,258

(22) Filed: Dec. 10, 2024

(30) Foreign Application Priority Data
Dec. 12, 2023 (CN) 202311708806.1

(51) Int. Cl. H02M 3/335; H02M 1/00

(52) U.S. Cl. CPC H02M 3/33592; H02M 1/0009

(57) ABSTRACT

A control circuit and method for an isolated switching-mode converter are disclosed. In the control circuit, before preparing to turn on a primary transistor switch in a primary-side circuit, preferably, a secondary-side controller transmits an inquiry signal to a primary-side controller, and the primary-side controller transmits, after confirming that it has been prepared, a feedback signal to the secondary-side controller to allow the secondary-side controller to turn off a synchronous rectifier transistor based on the feedback signal. After that, the primary-side controller turns on the primary transistor. In other words, in the control circuit and method of the present invention, in preparation for turning on the primary transistor switch, information exchange is conducted between the primary and secondary sides to make sure that the primary transistor switch is turned on after the synchronous rectifier transistor is turn off.

### CROSS-REFERENCE TO RELATED APPLICATION

This application claims the priority of Chinese patent application number 202311708806.1, filed on Dec. 12, 2023 and entitled “CONTROL CIRCUIT AND METHOD FOR ISOLATED SWITCHING-MODE CONVERTER”, the entire contents of which are incorporated herein by reference.

### TECHNICAL FIELD

The present invention relates to the field of electronic circuits, and in particular to a control circuit and method for an isolated switching-mode converter.

### BACKGROUND

With the rapid development of large-scale and very-large-scale integrated circuits, small and efficient isolated switching-mode converters have been widely used in various power supply systems. An isolated switching-mode converter typically includes a primary-side circuit and a secondary-side circuit, and a stable output of the secondary-side circuit can be obtained by controlling turn-on and turn-off of a power switch in the primary-side circuit. In addition, during operation of the isolated switching-mode converter, it is necessary to interlock turn-on of a power transistor switch in the primary-side circuit with a synchronous rectifier transistor in the secondary-side circuit to prevent common conduction of the primary and secondary-side circuits. However, in practical use, there remains a chance of common conduction of the primary and secondary-side circuits caused, for example, by false turn-on of the synchronous rectifier transistor in the secondary-side circuit.

Therefore, there is a need for a control circuit and method for preventing cross-conduction of primary and secondary-side circuits in an isolated switching-mode converter and thereby improving its safety performance and reliability.

### SUMMARY OF THE INVENTION

It is an object of the present invention to provide a control circuit for an isolated switching-mode converter, which overcomes the problem of possible cross-conduction of primary and secondary-side circuits arising from the use of conventional isolated switching-mode converters.

To this end, the present invention provides a control circuit for controlling an isolated switching-mode converter. The isolated switching-mode converter comprises a primary-side circuit, a secondary-side circuit and a transformer coupled between the primary-side and secondary-side circuits. The control circuit comprises: a primary-side controller comprising an output terminal that is electrically connected to a control terminal of a primary transistor switch in the primary-side circuit and is configured to output a control signal for the primary transistor switch; and a secondary-side controller comprising an output terminal that is electrically connected to a control terminal of a synchronous rectifier transistor in the secondary-side circuit and is configured to output a control signal for the synchronous rectifier transistor. The primary-side controller detects, when receiving an inquiry signal from the secondary-side controller, a state of the primary transistor switch and if the primary transistor switch is turned off, and the primary-side controller transmits a feedback signal to the secondary-side controller. The secondary-side controller controls the synchronous rectifier transistor to be turned off based on the feedback signal. The primary-side controller controls the primary transistor switch in the primary-side circuit to be turned on after the synchronous rectifier transistor is turned off.

Optionally, the secondary-side controller may be configured to receive an output voltage of the switching-mode converter and to transmit the inquiry signal when the output voltage of the switching-mode converter is below a predetermined voltage.

Optionally, the secondary-side controller may further be configured to transmit, after turning off the synchronous rectifier transistor based on the feedback signal, a first indication signal to the primary-side controller, thereby prompting the primary-side controller to turn on the primary transistor switch.

Optionally, the primary-side controller may be configured to control the primary transistor switch to be turned on after a predefined period of time following transmission of the feedback signal, wherein the predefined period of time ends later than a time when the synchronous rectifier transistor has been turned off.

Optionally, the primary-side controller may further be configured to transmit a second indication signal when the primary transistor switch is turned off, thereby prompting the secondary-side controller to turn on the synchronous rectifier transistor.

Optionally, the secondary-side controller may further be configured to detect a voltage signal from a secondary-side winding in the transformer and turn on the synchronous rectifier transistor when the voltage signal from the secondary-side winding drops to a predetermined value as a result of the primary transistor switch being turned off.

Optionally, the secondary-side controller may further be configured to detect a secondary-side current in the secondary-side circuit and turn off the synchronous rectifier transistor when detecting that the secondary-side current drops to a first preset current during turn-on period of the synchronous rectifier transistor.

Optionally, the secondary-side controller may further be configured to: detect the output voltage of the switching-mode converter in real time during the turn-on period of the synchronous rectifier transistor; when the output voltage of the switching-mode converter drops to the predetermined voltage, transmit to the primary-side controller an inquiry signal to prepare for starting the next switching period; and turn off the synchronous rectifier transistor when receiving a feedback signal from the primary-side controller.

Optionally, the secondary-side controller may comprise a first logic control module, a first transmitter module and a first receiver module, wherein a first output terminal of the first logic control module is electrically connected to the control terminal of the synchronous rectifier transistor and is configured to provide the control signal to the synchronous rectifier transistor; a second output terminal of the first logic control module is electrically connected to the first transmitter module and is configured to transmit a generated signal to the primary-side controller via the first transmitter module; and the first input terminal of the first logic control module is also electrically connected to the first receiver module and is configured to receive a signal from the primary-side controller via the first receiver module.

Optionally, the primary-side controller may comprise a second logic control module, a second receiver module and a second transmitter module, wherein an input terminal of the second logic control module is connected to the second receiver module and is configured to receive a signal from the secondary-side controller via the second receiver module; a first output terminal of the second logic control module is electrically connected to the control terminal of the primary transistor switch and is configured to provide the control signal to the primary transistor switch; and a second output terminal of the second logic control module is electrically connected to the second transmitter module and is configured to transmit a generated signal via the second transmitter module.

Optionally, the control circuit may further comprise at least one isolator coupled between the primary-side controller and the secondary-side controller, wherein the isolator enables a signal from the secondary-side controller and a signal from the primary-side controller to be transmitted to one another.

Optionally, the control circuit may comprise a first isolator and a second isolator, each coupled between the primary-side controller and the secondary-side controller, wherein the first isolator is configured to couple a signal from the secondary-side controller to the primary-side controller, and wherein the second isolator is configured to couple a signal from the primary-side controller to the secondary-side controller.

The present invention also provides a control method for an isolated switching-mode converter comprising a primary-side circuit, a secondary-side circuit and a transformer coupled between the primary-side and secondary-side circuits. The control method comprises: at the secondary-side controller, transmitting an inquiry signal to the primary-side controller; at the primary-side controller, receiving the inquiry signal and transmitting a feedback signal to the secondary-side controller; at the secondary-side controller, receiving the feedback signal and providing a turn-off signal to a synchronous rectifier transistor in the secondary-side circuit, thereby turning off the synchronous rectifier transistor; and at the primary-side controller, after the synchronous rectifier transistor is turned off, providing a turn-on signal to a primary transistor switch, thereby turning on the primary transistor switch.

Optionally, the secondary-side controller may receive an output voltage of the switching-mode converter and transmit the inquiry signal when the output voltage of the switching-mode converter is below a predetermined voltage.

Optionally, the secondary-side controller may transmit a first indication signal to the primary-side controller after turning off the synchronous rectifier transistor based on the feedback signal, wherein the primary-side controller controls the primary transistor switch to be turned on based on the first indication signal.

Optionally, the primary-side controller may provide the turn-on signal to the primary transistor switch after a predefined period of time following transmission of the feedback signal, thereby turning on the primary transistor switch, wherein the predefined period of time ends later than a time when the synchronous rectifier transistor has been turned off.

Optionally, the primary-side controller may further transmit a second indication signal when the primary transistor switch is turned off, wherein the secondary-side controller provides, based on the second indication signal, the turn-on signal to the synchronous rectifier transistor, thereby controlling the synchronous rectifier transistor to be turned on.

Optionally, the secondary-side controller may detect a voltage signal from a secondary-side winding in the transformer and provide the turn-on signal to the synchronous rectifier transistor when the voltage signal from the secondary-side winding drops to a predetermined value as a result of the primary transistor switch being turned off, thereby controlling the synchronous rectifier transistor to be turned on.

Optionally, the secondary-side controller may further detect a secondary-side current in the secondary-side circuit and control the synchronous rectifier transistor to be turned off when detecting that the secondary-side current drops to a first preset current during turn-on period of the synchronous rectifier transistor, thereby turning off the synchronous rectifier transistor.

Optionally, the secondary-side controller may further detect the output voltage of the switching-mode converter in real time during the turn-on period of the synchronous rectifier transistor, transmit to the primary-side controller an inquiry signal to prepare for starting the next switching period when the output voltage of the switching-mode converter drops to the predetermined voltage, and turn off the synchronous rectifier transistor when receiving a feedback signal from the primary-side controller.

In the control circuit of the present invention, before preparing to turn on the primary transistor switch in the primary-side circuit, preferably, the secondary-side controller transmits an inquiry signal to the primary-side controller, and the primary-side controller transmits, after confirming that it has been prepared, a feedback signal to the secondary-side controller to allow the secondary-side controller to control the synchronous rectifier transistor to be turned off based on the feedback signal. After that, the primary-side controller turns on the primary transistor. In other words, in the control circuit and method of the present invention, in preparation for turning on the primary transistor switch, information exchange is conducted between the primary and secondary sides to ensure that the primary transistor switch is turned on after the synchronous rectifier transistor is turn off. This prevents false turn-on of the synchronous rectifier transistor while the primary transistor switch is being in an ON state, which may lead to cross-conduction of the primary and secondary sides. Therefore, the risk of common conduction of the primary and secondary sides can be effectively reduced.

Further, in practical applications, one or more magnetic isolator, capacitive isolator, digital isolator or other isolators may be used between the primary and secondary-side controllers in the control circuit of the present invention, which enable two-way communication between the primary and secondary sides, resulting in faster response and lower system power consumption.

### BRIEF DESCRIPTION OF THE DRAWINGS

FIG. 1 is a schematic circuit diagram of an isolated switching-mode converter coupled to a control circuit according to an embodiment of the present invention.

FIG. 2 is a schematic waveform diagram of key signals in DCM operation of the isolated switching-mode converter coupled to the control circuit according to an embodiment of the present invention.

FIG. 3 is a schematic waveform diagram of key signals in CCM operation of the isolated switching-mode converter coupled to the control circuit according to an embodiment of the present invention.

FIG. 4 is a schematic waveform diagram of key signals in CCM operation of the isolated switching-mode converter coupled to the control circuit according to an alternative embodiment of the present invention.

### DETAILED DESCRIPTION

Control circuits and methods for an isolated switching-mode converter according to the present invention will be described in greater detail below with reference to the accompanying drawings, which illustrate specific embodiment thereof. From the following description, advantages and features of the invention will become apparent. Note that the figures are provided in a very simplified form not necessarily drawn to exact scale for the only purpose of helping to explain the disclosed embodiments in a more convenient and clearer way. As used herein, the terms “time”, “conduction time period” and “conduction time” each refer to a period of time, and the term “instant”, “when” and “turn-off instant” each refer to a point of time at which an event occurs. As used herein, the terms “valid level” and “high level” each refer to an electrical level indicative of an action to be taken by a designated element or module, which is detectable and determined to be valid, and the terms “invalid level” and “low level” each refer to an electrical level indicative of an action to be taken by a designated element or module, which is detectable but determined to be invalid, or is undetectable. The term “signal” refers to an electrical/magnetic signal, which can be represented by a particular waveform, or refers to information transmitted in a circuit, which can be represented by a particular value.

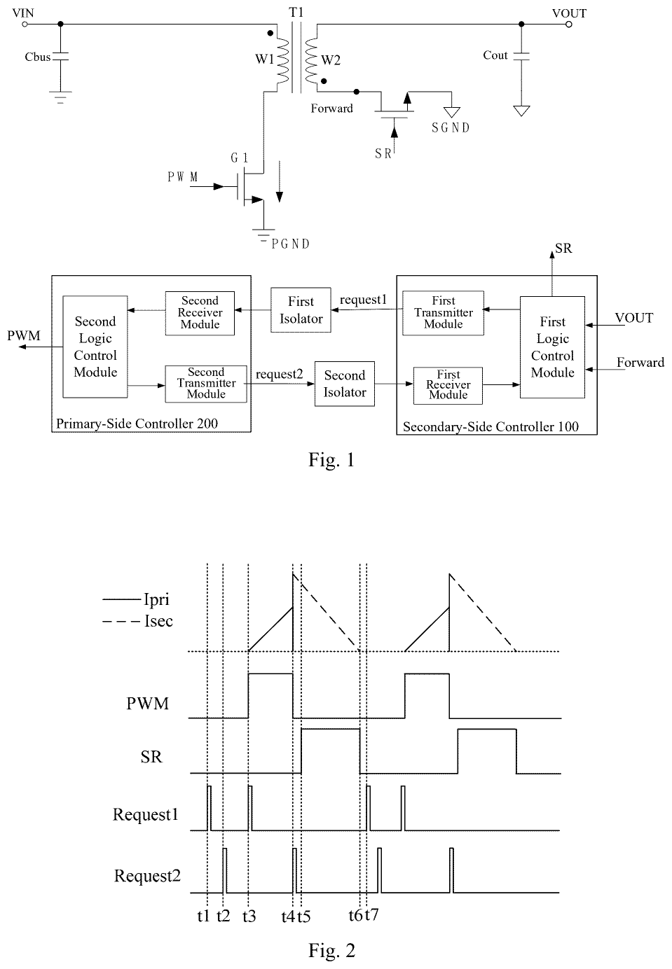

FIG. 1 is a schematic circuit diagram of an isolated switching-mode converter coupled to a control circuit according to an embodiment of the present invention. As shown in FIG. 1, the isolated switching-mode converter includes a primary-side circuit, a secondary-side circuit and a transformer T1 coupled between the primary and secondary-side circuits to provide electrical isolation. The primary and secondary-side circuits are electrically isolated and are connected to different ground terminals. The transformer T1 includes a primary-side winding W1 and a secondary-side winding W2. The primary-side circuit is coupled to the primary-side winding W1 of the transformer T1, and the secondary-side circuit is coupled to the secondary-side winding W2 of the transformer T1.

With continued reference to FIG. 1, the control circuit includes a primary-side controller 200 and secondary-side controller 100. The primary-side controller 200 has an output terminal electrically connected to a control terminal of a primary transistor switch G1 in the primary-side circuit and configured to output a control signal PWM for the primary transistor switch G1, so as to turn on or turn off the primary transistor switch G1. The secondary-side controller 100 has an output terminal electrically connected to a control terminal of a synchronous rectifier transistor SR in the secondary-side circuit and configured to output a control signal for the synchronous rectifier transistor SR, so as to control turn-on or turn-off of the synchronous rectifier transistor SR. In other words, the primary-side controller 200 can be used to control turn-on and turn-off the primary transistor switch G1, and the secondary-side controller 100 can be used to control turn-on and turn-off the synchronous rectifier transistor SR.

In one example, the primary-side circuit may include an input capacitor Cbus and the primary transistor switch G1. A first terminal of the input capacitor Cbus is coupled to the primary-side winding W1 of the transformer T1, and a second terminal of the input capacitor Cbus is connected to the ground terminal for the primary-side circuit. For example, the primary transistor switch G1 may be a power transistor switch. A drain of the power transistor switch is connected to the primary-side winding W1 of the transformer T1. A source of the power transistor switch is connected to the ground terminal for the primary-side circuit. A gate of the power transistor switch is connected to the primary-side controller 200 in order to receive the control signal PWM for the primary transistor switch G1.

In one example, the secondary-side circuit may include the synchronous rectifier transistor SR and an output capacitor Cout. A first terminal of the output capacitor Cout is coupled to the secondary-side winding W2 of the transformer T1 and is coupled to a load. A second terminal of the output capacitor Cout is connected to the ground terminal for the secondary-side circuit. For example, the synchronous rectifier transistor SR may be a power transistor switch. A drain of the power transistor switch is connected to the secondary-side winding W2 of the transformer T1. A source of the power transistor switch is connected to the ground terminal for the secondary-side circuit. A gate of the power transistor switch is connected to the secondary-side controller 100, in order to receive the control signal for the synchronous rectifier transistor SR.

In addition, the secondary-side controller 100 of this embodiment may also be coupled to the secondary-side winding W2 of the transformer T1, in order to receive a voltage signal Forward from the secondary-side winding W2 of the transformer T1. In specific implementations, the secondary-side controller 100 may determine whether the primary transistor switch G1 in the primary-side circuit is turned on or turned off by sensing the voltage signal Forward from the secondary-side winding W2. For example, when the voltage signal Forward from the secondary-side winding W2 drops to a predetermined value, it may provide an indication of an OFF state of the primary transistor switch G1. The secondary-side controller 100 may also be configured to detect an output voltage Vout of the switching-mode converter. Optionally, the output voltage Vout may be used as basis for controlling the timing of the switching-mode converter starting a new switching period. For example, when the output voltage Vout is below a predetermined voltage, it may provide a prompt for the circuit to enter the next switching period.

In the control circuit of this embodiment, the primary-side controller 200 and the secondary-side controller 100 ensure, through information exchange, that the synchronous rectifier transistor SR is turned off before the primary transistor switch G1 is controlled to be turned on. Similarly, it can be ensured that the synchronous rectifier transistor SR is controlled to be turned on after the primary transistor switch G1 is turned off. In this way, the common conduction of the primary and secondary sides can be effectively addressed.

Specifically, in preparation for starting a new switching period, the primary-side controller 200 is configured to receive an inquiry signal request1_0 transmitted from the secondary-side controller 100 and perform a self-check (e.g., the self-check may involve checking whether the primary transistor switch G1 in the primary-side circuit has been turned off, i.e., whether it is in an OFF state; making sure that every modules in the primary-side controller 200 has been prepared; and so forth), followed by entry into a ready state. For example, as shown in FIGS. 2 to 4, at instant t1, the secondary-side controller 100 transmits the inquiry signal request1_0 (represented by the first pulse in waveform Request1 of FIGS. 2 to 4; and other signals such as request1_1 are incremented from request1_0) to the primary-side controller 200.

Optionally, the secondary-side controller 100 may also be configured to receive the output voltage Vout of the switching-mode converter and transmit the inquiry signal request1_0 upon the output voltage Vout of the switching-mode converter being below the predetermined voltage, to prepare for starting a new switching period. In this way, stability of the output voltage Vout can be ensured.

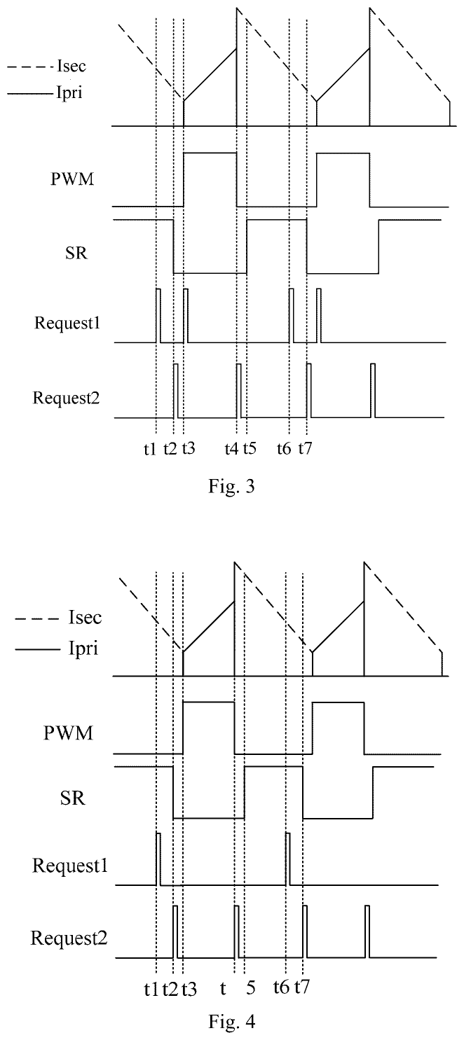

Additionally, the primary-side controller 200 may control turn-on of the primary transistor switch G1 in the primary-side circuit after ensuring that the synchronous rectifier transistor SR has been turned off, thereby starting a new switching period. The primary-side controller 200 controls turn-on of the primary transistor switch G1 in the primary-side circuit to start a new switching period may include: the primary-side controller 200 may perform a self-check upon receipt of the inquiry signal request1_0 and, after the self-check is completed, may transmit a feedback signal request2_0 to the secondary-side controller 100, which indicates that the primary-side controller 200 has been prepared; and the secondary-side controller 100 may control turn-off of the synchronous rectifier transistor SR based on the feedback signal request2_0 (in particular, the secondary-side controller 100 may provide a turn-off signal to the synchronous rectifier transistor SR based on the feedback signal request2_0, the turn-off signal can control turn-off of the synchronous rectifier transistor SR if the synchronous rectifier transistor SR is in an ON state, or keep the synchronous rectifier transistor SR in an OFF state if the synchronous rectifier transistor SR is already OFF); and then, the primary-side controller 200 turns on the primary transistor switch G1 in the primary-side circuit. For example, as shown in FIG. 2, at t2, the primary-side controller 200 may complete the self-check and transmit the feedback signal request2_0 to the secondary-side controller 100, and the secondary-side controller 100 may responsively provide the turn-off signal to the synchronous rectifier transistor SR, to ensure that the synchronous rectifier transistor SR is kept OFF. Alternatively, in the example of FIGS. 3 and 4, at t2, the primary-side controller 200 may complete the self-check and transmit the feedback signal request2_0 to the secondary-side controller 100 (represented by the first pulse in waveform Request2 of FIGS. 2 to 4; and other signals such as request2_1 are incremented from request2_0), and the secondary-side controller 100 may then control the synchronous rectifier transistor SR to be turned off based on the feedback signal request2_0.

How the primary-side controller 200 ensures that the primary transistor switch G1 is controlled to be turned on after the synchronous rectifier transistor SR is turned off is described below by ways of several specific examples.

In a first example, when confirming that the synchronous rectifier transistor SR is turned off, the secondary-side controller 100 is further configured to transmit a first indication signal request1_1 to the primary-side controller 200, prompting the primary-side controller 200 to turn on the primary transistor switch G1 in the primary-side circuit based on the first indication signal request1_1. In other words, in this example, the primary-side controller 200 controls the timing of turn-on of the primary transistor switch G1 based on the first indication signal request1_1. Once the primary-side controller 200 receives the first indication signal request1_1, it means that the synchronous rectifier transistor SR is confirmed to be turned off. Accordingly, the primary transistor switch G1 is controlled to be turned on. In this way, the problem of common conduction of the primary and secondary sides can be effectively circumvented. For example, as shown in FIGS. 2 and 3, at t3, the secondary-side controller 100 confirms that the synchronous rectifier transistor SR is turned off, and then transmits the first indication signal request1_1 to the primary-side controller 200. In response, the primary-side controller 200 controls the turn-on of the primary transistor switch G1 in the primary-side circuit based on the first indication signal request1_1.

It is noted that the secondary-side controller 100 may generate the inquiry signal request1_0 when the output voltage Vout of the switching-mode converter is below the predetermined voltage. base on this, after receiving the feedback signal request2_0 and responsively turning off the synchronous rectifier transistor SR, the secondary-side controller 100 may directly transmit the first indication signal request1_1.

In a second example, the primary-side controller 200 may control turn-on of the primary transistor switch G1 in the primary-side circuit after a predefined period of time following the transmission of the feedback signal request2_0. Here, the predefined period of time ends later than a time when the synchronous rectifier transistor SR is turned off, ensuring that the primary transistor switch G1 is turned on after the synchronous rectifier transistor SR is turned off. In other words, in this example, the primary-side controller 200 reserves a period of time, after it transmits the feedback signal request2_0, for the secondary-side controller 100 to turn off the synchronous rectifier transistor SR, and then turns on the primary transistor switch G1. This can also effectively circumvent the problem of common conduction of the primary and secondary sides. For example, as shown in FIG. 4, the primary-side controller 200 may transmit the feedback signal request2_0 at t2 and turn on the primary transistor switch G1 at t3, and the synchronous rectifier transistor SR may be turned off at a time earlier than t3 (e.g., t2).

In addition, once the primary transistor switch G1 is turned on, a primary-side current Ipri in the primary-side circuit will ramp up. In specific examples, the primary-side controller 200 may control the primary transistor switch G1 to be turned off when the primary-side current Ipri rises to a second preset current. Further, after it has been confirmed that the primary transistor switch G1 is turned off, the secondary-side controller 100 may control the synchronous rectifier transistor SR in the secondary-side circuit to be turned on. For example, as shown in FIGS. 2 to 4, the primary transistor switch G1 may be controlled to be turned off in response to the primary-side current Ipri rising to the second preset current at t4, and the synchronous rectifier transistor SR may be controlled to be turned on at t5.

How the secondary-side controller 100 makes sure to turn on the synchronous rectifier transistor SR after the primary transistor switch G1 is turned off is described below by ways of several specific examples.

In one example, the primary-side controller 200 is further configured to transmit a second indication signal request2_1 at the time when the primary transistor switch G1 is turned off, prompting the secondary-side controller 100 to control the synchronous rectifier transistor SR to be turned on when receiving the second indication signal request2_1. In other words, in this example, the secondary-side controller 100 controls the timing of turning on the synchronous rectifier transistor SR based on the second indication signal request2_1. Receipt of the second indication signal2_1 by the secondary-side controller 100 indicates that the primary transistor switch G1 has been confirmed to be turned off. Accordingly, the synchronous rectifier transistor SR can be turned on. In this way, the problem of common conduction of the primary and secondary sides can be effectively circumvented. For example, as shown in FIGS. 2 to 4, at t4, the primary-side current Ipri may rise to second preset current, in response, the primary transistor switch G1 may be turned off, and the second indication signal request2_1 may be transmitted. The secondary-side controller 100 may turn on the synchronous rectifier transistor SR later at t5.

In another example, the secondary-side controller 100 may also be configured to detect the voltage signal Forward from the secondary-side winding W2 and turn on the synchronous rectifier transistor SR when the voltage signal Forward from the secondary-side winding W2 drops to the predetermined value as a result of the primary transistor switch G1 being turned off. In other words, in this example, the secondary-side controller 100 detects the voltage signal Forward from the secondary-side winding W2 by itself, and turns on the synchronous rectifier transistor SR in response to the voltage signal Forward from the secondary-side winding W2 dropping to the predetermined value, which indicates that the primary transistor switch G1 has been turned off. This can also effectively circumvent the problem of common conduction of the primary and secondary sides.

In specific examples, after the synchronous rectifier transistor SR is turned on, the secondary-side controller 100 may continue detecting the output voltage Vout of the switching-mode converter in real time. Moreover, it may determine whether the switching-mode converter gets prepared to start the next switching period based on the output voltage Vout. Moreover, the secondary-side controller 100 may transmit the inquiry signal request1_0 to the primary-side controller 200 when the output voltage Vout of the switching-mode converter is below the predetermined voltage, and may provide the turn-off signal to the synchronous rectifier transistor SR upon receiving the feedback signal request2_0 from the primary-side controller 200, in order to be ready for the start of the next switching period.

It is noted that the control circuit of this disclosure may be suitably used with the isolated switching-mode converter, whether it operates in a continuous conduction mode (CCM), or in a discontinuous conduction mode (DCM).

A particular structural implementation of the control circuit is described below with continued reference to FIG. 1.

As shown in FIG. 1, the secondary-side controller 100 may particularly include a first logic control module, a first transmitter module and a first receiver module.

A first output terminal of the first logic control module is electrically connected to the control terminal of the synchronous rectifier transistor SR, in order to provide the control signal to the synchronous rectifier transistor SR. A second output terminal of the first logic control module is electrically connected to the first transmitter module, in order to allow a generated signal to be transmitted by the first transmitter module. For example, the first logic control module may generate the inquiry signal request1_0, which may be transmitted by the first transmitter module.

A first input terminal of the first logic control module is electrically connected to the first receiver module, in order to receive signals request2 from the primary-side controller 200 via the first receiver module. For example, the feedback signal request2_0 may be received from the primary-side controller 200 via the first receiver module, to enable the first logic control module to provide, upon receipt of feedback signal request2_0, the turn-off signal to the synchronous rectifier transistor SR to control the synchronous rectifier transistor SR to be turned off. Moreover, the second indication signal request2_1 may also be received from the primary-side controller 200 via the first receiver module, to enable the first logic control module to generate a turn-on signal for the synchronous rectifier transistor SR based on the second indication signal request2_1.

Optionally, in addition to confirming that the synchronous rectifier transistor SR is turned off based on the feedback signal request2_0, the first logic control module may also be configured to generate the first indication signal request1_1 and transmit it to the primary-side controller 200 through the first transmitter module, prompting the primary-side controller 200 to turn on the primary transistor switch G1.

The first logic control module may also have a second input terminal, which may be electrically connected to an output terminal of the secondary-side winding W2 of the transformer T1, in order to receive the voltage signal Forward from the secondary-side winding W2. In specific examples, the first logic control module may be configured to generate the turn-on signal for the synchronous rectifier transistor SR based on the voltage signal Forward. For example, the first logic control module may generate the turn-on signal for the synchronous rectifier transistor SR when the primary transistor switch G1 has been turned off and the voltage signal Forward dropping to the predetermined value has been detected. In the present embodiment, the first logic control module also has a third input terminal further configured to receive the output voltage Vout of the switching-mode converter. In one example, the first logic control module may take the output voltage Vout as a basis for determining the time of generating the inquiry signal request1_0. For example, the inquiry signal request1_0 may be generated when the output voltage Vout is below the predetermined voltage.

With continued reference to FIG. 1, the primary-side controller 200 may particularly include a second logic control module, a second receiver module and a second transmitter module.

An input terminal of the second logic control module is connected to the second receiver module, in order to receive signals request1 from the secondary-side controller 100 through the second receiver module, such as the inquiry signal request1_0 and the first indication signal request1_1 from the secondary-side controller 100. A first output terminal of the second logic control module is electrically connected to the control terminal of the primary transistor switch G1, in order to provide the control signal PWM to the primary transistor switch G1. For example, the second logic control module may provide the turn-on signal to the primary transistor switch G1 when receiving the first indication signal request1_1. A second output terminal of the second logic control module is electrically connected to the second transmitter module, in order to transmit generated information to the second transmitter module. The second transmitter module may then further send the information out. For example, the second logic control module may generate the feedback signal request2_0 after a self-check is completed, which may be then sent out by the second transmitter module. Additionally, the second logic control module may generate the second indication signal request2_1 after the primary transistor switch G1 is turned off, which may also be then sent out by the second transmitter module.

In specific examples, the control circuit further includes an isolator coupled between the primary-side controller 200 and the secondary-side controller 100 and configured to isolate the primary-side controller 200 from the secondary-side controller 100. Additionally, the secondary-side controller 100 and the primary-side controller 200 may exchange information via the isolator. That is, through the isolator, signals may be transmitted from the secondary-side controller 100 to the primary-side controller 200, and signals may be transmitted from the primary-side controller 200 to the secondary-side controller 100.

In one example, the control circuit may include a single isolator, wherein the primary-side controller 200 and the secondary-side controller 100 exchange information via the single isolator. In an alternative example, for example, as shown in FIG. 1, the control circuit may include a first isolator and a second isolator. The first isolator is configured to couple signals request1 from the secondary-side controller 100 to the primary-side controller 200, and the second isolator is configured to couple signals request2 from the primary-side controller 200 to the secondary-side controller 100. It will be recognized that only one isolator may be provided in alternative examples and time-division multiplexed to transmit signals from the secondary-side controller 100 to the primary-side controller 200, and from the primary-side controller 200 to the secondary-side controller 100. The first and second isolators may be both implemented as, for example, magnetic isolators, capacitive isolators, digital isolators or other isolators.

Three exemplary control methods for the isolated switching-mode converter according to the present invention, which can be implemented by the control circuit as defined above, are described in detail below.

### Embodiment 1

In a first embodiment, the isolated switching-mode converter operates in a discontinuous conduction mode (DCM). A complete switching period is described below with combined reference to the waveforms of the key signals shown in FIGS. 1 and 2. It is noted that, in FIG. 2, Request1 represents a signal from the secondary-side controller 100, and Request2 represents a signal from the primary-side controller 200.

At t1, the secondary-side controller 100 may transmit an inquiry signal request1_0 to the primary-side controller 200 via the first isolator, getting ready to start a new switching period. As noted above, the secondary-side controller 100 may transmit the inquiry signal request1_0 when detecting that the output signal Vout of the switching-mode converter drops to a predetermined voltage. After receiving the inquiry signal request1_0, the primary-side controller 200 carries out a self-check and enters a ready state.

At t2, in the ready state after the self-check is completed, the primary-side controller 200 may transmit a feedback signal request2_0 to the secondary-side controller 100 via the second isolator. Upon receiving the feedback signal request2_0, the secondary-side controller 100 checks if the synchronous rectifier transistor SR is turned off and ensures that the synchronous rectifier transistor SR is in an OFF state. In embodiment 1, the synchronous rectifier transistor SR is maintained OFF after the secondary-side controller 100 receives the feedback signal request2_0.

At t3, the secondary-side controller 100 confirms that the synchronous rectifier transistor SR is in an OFF state and transmits a first indication signal request1_1 to the primary-side controller 200 via the first isolator, prompting the primary-side controller 200 to control the primary transistor switch G1 to be turned on. In a specific example, after confirming that the synchronous rectifier transistor SR is in an OFF state, the secondary-side controller 100 may directly transmit the first indication signal request1_1 to the primary-side controller 200.

As a result of the primary transistor switch G1 being turned on, a primary-side current Ipir in the primary-side circuit ramps up. At t4, upon the primary-side current Ipir rising to a second preset current, the primary-side controller 200 controls the primary transistor switch G1 to be turned off and transmits a second indication signal request2_1 through the second isolator.

At t5, the secondary-side controller 100 receives the second indication signal request2_1 which indicates that the primary transistor switch G1 has been turned off and responsively turns on the synchronous rectifier transistor SR.

As a result of the primary transistor switch G1 being turned off and the synchronous rectifier transistor SR being turned on, a secondary-side current Isec in the secondary-side circuit ramps down until completion of demagnetization of the secondary-side circuit. At t6, the secondary-side controller 100 controls the synchronous rectifier transistor SR to be turned off.

At this point, the switching period ends. When the output voltage Vout of the switching-mode converter again is below the predetermined voltage, the secondary-side controller 100 may again provide an inquiry signal request1_0 to the primary-side controller 200, getting ready to start the next switching period.

### Embodiment 2

In a second embodiment, the isolated switching-mode converter operates in a continuous conduction mode (CCM). A complete switching period is described below with combined reference to the waveforms of the key signals shown in FIGS. 1 and 3. It is noted that, in FIG. 3, Request represents a signal from the secondary-side controller 100, and Request2 represents a signal from the primary-side controller 200.

At t1, the secondary-side controller 100 may transmit an inquiry signal request1_0 to the primary-side controller 200 via the first isolator, getting ready to start a new switching period. In Embodiment 2, the secondary-side controller 100 may transmit the inquiry signal request1_0 when detecting that the output signal Vout of the switching-mode converter drops to a predetermined voltage. After receiving the inquiry signal request1_0, the primary-side controller 200 carries out a self-check and enters a ready state.

At t2, in the ready state after the self-check is completed, the primary-side controller 200 may transmit a feedback signal request2_0 to the secondary-side controller 100 via the second isolator, and the secondary-side controller 100 may then turn off the synchronous rectifier transistor SR based on the feedback signal request2_0.

At t3, after turning off the synchronous rectifier transistor SR, the secondary-side controller 100 may transmit a first indication signal request1_1 to the primary-side controller 200 via the first isolator, prompting the primary-side controller 200 to turn on the primary transistor switch G1.

As a result of the primary transistor switch G1 being turned on, a primary-side current Ipir in the primary-side circuit ramps up. At t4, upon the primary-side current Ipir rising to a second preset current, the primary-side controller 200 controls the primary transistor switch G1 to be turned off and transmits a second indication signal request2_1 through the second isolator.

At t5, upon receipt of the second indication signal request2_1, the secondary-side controller 100 turns on the synchronous rectifier transistor SR.

During the turn-on period of the synchronous rectifier transistor SR, the secondary-side controller 100 continues detecting the output voltage Vout of the switching-mode converter in real time. At t6 the output voltage Vout drops below the predetermined voltage, the secondary-side controller 100 transmits an inquiry signal request1_0 for prompting preparation for starting the next switching period. When receiving the inquiry signal request1_0, the primary-side controller 200 carries out a self-check.

At t7, after the self-check is completed, the primary-side controller 200 transmits a feedback signal request2_0 to the secondary-side controller 100. The secondary-side controller 100 receives the feedback signal request2_0 and responsively turns off the synchronous rectifier transistor SR. At this point, the current switching period ends, and the next switching period starts.

### Embodiment 3

A third embodiment differs from the first and second embodiments in that the primary transistor switch G1 is turned on after a predefined period of time following the primary-side controller 200 transmitting a feedback signal request2_0. In contrast, in the first and second examples, the primary transistor switch G1 is turned on when the secondary-side controller 100 transmits a first indication signal request1_1.

In particular, combined reference can be made to the waveforms of the key signals shown in FIGS. 1 and 4. It is noted that Embodiment 3 is also set forth in the exemplary context of CCM operation. In FIG. 4, Request1 represents a signal from the secondary-side controller 100, and Request2 represents a signal from primary-side controller 200.

At t1 and t2, with similarity to the embodiment of FIG. 3, the secondary-side controller 100 transmits an inquiry signal request1_0 to the primary-side controller 200 via the first isolator, getting ready to start a new switching period. In particular, the secondary-side controller 100 may transmit the inquiry signal request1_0 when detecting that the output signal Vout of the switching-mode converter drops to a predetermined voltage. When receiving the inquiry signal request1_0, the primary-side controller 200 carries out a self-check and enters a ready state, in which it transmits a feedback signal request2_0) to the secondary-side controller 100 via the second isolator. The secondary-side controller 100 then turns off the synchronous rectifier transistor SR based on the feedback signal request2_0.

At t3, the primary-side controller 200 turns on the primary transistor switch G1 a predefined period of time after it transmits the feedback signal request2_0. It will be recognized that the predefined period of time after the feedback signal request2_0 is transmitted ends later than a time when the synchronous rectifier transistor SR is turned off. In particular, as shown in FIG. 4, the synchronous rectifier transistor SR may be turned off at t2, and the primary transistor switch G1 may be turned on at t3.

At t4 and t5, with similarity to the embodiment of FIG. 3, when a primary-side current Ipir in the primary-side circuit ramps up to a second preset current, the primary-side controller 200 controls the primary transistor switch G1 to be turned off and transmits a second indication signal request2_1 via the second isolator. After that, upon receipt of the second indication signal request2_1, the secondary-side controller 100 turns on the synchronous rectifier transistor SR.

Afterwards, the above-described actions at t1 and t2 are repeated, ending the current switching period and getting ready to start the next switching period.

It is noted that the embodiments disclosed herein are described in a progressive manner, with the description of each embodiment focusing on its differences from others. Reference can be made between the embodiments for their identical or similar features. Since the system embodiments correspond to the method embodiments, cross-reference can be made therebetween. While the invention has been described above with reference to preferred embodiments thereof, it is not limited to these embodiments. In light of the above teachings, any person familiar with the art may make many possible modifications and variations to the disclosed embodiments or adapt them into equivalent embodiments, without departing from the scope of the invention. Accordingly, it is intended that any and all simple variations, equivalent alternatives and modifications made to the foregoing embodiments based on the substantive disclosure of the invention without departing from the scope thereof fall within the scope.

It is understood that, as used herein, the terms “first”, “second”, “third” and the like are only meant to distinguish various components, elements, steps, etc. from each other rather than indicate logical or sequential orderings thereof, unless otherwise indicated or specified. Further, it is also to be recognized that, as used herein and in the appended claims, the singular forms “a” and “an” include the plural reference unless the context clearly dictates otherwise. Thus, for example, a reference to “a step” or “a means” is a reference to one or more steps or means and may include sub-steps and sub-means. All conjunctions used are to be understood in the most inclusive sense possible.

What is claimed is:

1. A control circuit for controlling an isolated switching-mode converter, wherein the isolated switching-mode converter comprises a primary-side circuit, a secondary-side circuit and a transformer coupled between the primary-side and secondary-side circuits, and wherein the control circuit comprises:
a primary-side controller comprising an output terminal that is electrically connected to a control terminal of a primary transistor switch in the primary-side circuit and is configured to output a control signal for the primary transistor switch; and
a secondary-side controller comprising an output terminal that is electrically connected to a control terminal of a synchronous rectifier transistor in the secondary-side circuit and is configured to output a control signal for the synchronous rectifier transistor,
wherein the primary-side controller detects, when receiving an inquiry signal from the secondary-side controller, a state of the primary transistor switch and if the primary transistor switch is turned off, the primary-side controller transmits a feedback signal to the secondary-side controller; wherein the secondary-side controller controls the synchronous rectifier transistor to be turned off based on the feedback signal; and wherein the primary-side controller controls the primary transistor switch in the primary-side circuit to be turned on after the synchronous rectifier transistor is turned off.

2. The control circuit of claim 1, wherein the secondary-side controller is configured to receive an output voltage of the switching-mode converter and to transmit the inquiry signal when the output voltage of the switching-mode converter is below a predetermined voltage.

3. The control circuit of claim 1, wherein after controlling the synchronous rectifier transistor to be turned off based on the feedback signal, the secondary-side controller is further configured to transmit a first indication signal to the primary-side controller, thereby prompting the primary-side controller to turn on the primary transistor switch.

4. The control circuit of claim 1, wherein the primary-side controller is configured to control the primary transistor switch to be turned on after a predefined period of time following the transmission of the feedback signal, and wherein the predefined period of time ends later than a time when the synchronous rectifier transistor has been turned off.

5. The control circuit of claim 1, wherein the primary-side controller is further configured to transmit a second indication signal in case of the primary transistor switch being turned off, thereby prompting the secondary-side controller to control the synchronous rectifier transistor to be turned on.

6. The control circuit of claim 1, wherein the secondary-side controller is further configured to detect a voltage signal from a secondary-side winding in the transformer and to control the synchronous rectifier transistor to be turned on when the voltage signal from the secondary-side winding drops to a predetermined value as a result of the primary transistor switch being turned off.

7. The control circuit of claim 1, wherein the secondary-side controller is further configured to detect a secondary-side current in the secondary-side circuit and to control the synchronous rectifier transistor to be turned off when detecting that the secondary-side current drops to a first preset current during a turn-on period of the synchronous rectifier transistor.

8. The control circuit of claim 1, wherein the secondary-side controller comprises a first logic control module, a first transmitter module and a first receiver module, wherein:
a first output terminal of the first logic control module is electrically connected to the control terminal of the synchronous rectifier transistor and is configured to provide the control signal to the synchronous rectifier transistor;
a second output terminal of the first logic control module is electrically connected to the first transmitter module and is configured to transmit a generated signal to the primary-side controller via the first transmitter module; and
a first input terminal of the first logic control module is electrically connected to the first receiver module and is configured to receive a signal from the primary-side controller via the first receiver module.

9. The control circuit of claim 1, wherein the primary-side controller comprises a second logic control module, a second receiver module and a second transmitter module, wherein:
an input terminal of the second logic control module is connected to the second receiver module and is configured to receive a signal from the secondary-side controller via the second receiver module;
a first output terminal of the second logic control module is electrically connected to the control terminal of the primary transistor switch and is configured to provide the control signal to the primary transistor switch; and
a second output terminal of the second logic control module is electrically connected to the second transmitter module and is configured to transmit a generated signal to the secondary-side controller via the second transmitter module.

10. The control circuit of claim 1, further comprising an isolator coupled between the primary-side controller and the secondary-side controller, wherein the isolator enables a signal from the secondary-side controller and a signal from the primary-side controller to be transmitted to one another.

11. The control circuit of claim 1, further comprising a first isolator and a second isolator, each coupled between the primary-side controller and the secondary-side controller, wherein the first isolator is configured to couple a signal from the secondary-side controller to the primary-side controller, and wherein the second isolator is configured to couple a signal from the primary-side controller to the secondary-side controller.

12. A control method for an isolated switching-mode converter, wherein the isolated switching-mode converter comprises a primary-side circuit, a secondary-side circuit and a transformer coupled between the primary-side and secondary-side circuits, and wherein the control method comprises:
at the secondary-side controller, transmitting an inquiry signal to the primary-side controller;
at the primary-side controller, receiving the inquiry signal and then detecting a state of a primary transistor switch, wherein in case of the primary transistor switch being turned off, transmitting a feedback signal to the secondary-side controller;
at the secondary-side controller, receiving the feedback signal and providing a turn-off signal to a synchronous rectifier transistor in the secondary-side circuit, thereby controlling the synchronous rectifier transistor to be turned off; and
at the primary-side controller, providing a turn-on signal to a primary transistor switch in the primary-side circuit after the synchronous rectifier transistor is turned off, thereby controlling the primary transistor switch to be turned on.

13. The control method of claim 12, wherein the secondary-side controller receives an output voltage of the switching-mode converter and transmits the inquiry signal when the output voltage of the switching-mode converter is below a predetermined voltage.

14. The control method of claim 12, wherein the secondary-side controller further transmits, after controlling the synchronous rectifier transistor to be turned off based on the feedback signal, a first indication signal to the primary-side controller, wherein the primary-side controller controls the primary transistor switch to be turned on based on the first indication signal.

15. The control method of claim 12, wherein the primary-side controller provides the turn-on signal to the primary transistor switch after a predefined period of time following transmission of the feedback signal, thereby turning on the primary transistor switch, wherein the predefined period of time ends later than a time when the synchronous rectifier transistor has been turned off.

16. The control method of claim 12, wherein the primary-side controller further transmits a second indication signal when the primary transistor switch is turned off, and wherein the secondary-side controller provides, based on the second indication signal, the turn-on signal to the synchronous rectifier transistor, thereby controlling the synchronous rectifier transistor to be turned on.

17. The control method of claim 12, wherein the secondary-side controller detects a voltage signal from a secondary-side winding in the transformer and provides the turn-on signal to the synchronous rectifier transistor when the voltage signal from the secondary-side winding drops to a predetermined value as a result of the primary transistor switch being turned off, thereby controlling the synchronous rectifier transistor to be turned on.

18. The control method of claim 12, wherein the secondary-side controller further detects a secondary-side current in the secondary-side circuit and provides the turn-off signal to the synchronous rectifier transistor in the secondary-side circuit when detecting that the secondary-side current drops to a first preset current during a turn-on period of the synchronous rectifier transistor, thereby controlling the synchronous rectifier transistor to be turned off.

19. An isolated switching-mode converter comprising the control circuit of claim 1.
